(19) United States
(12) Patent Application Publication
(10) Pub. No.: US 2024/0383366 A1
(43) Pub. Date: Nov. 21, 2024

(54) DETERMINATION OF CHARGE STOP TIME

(71) Applicant: LIIKENNEVIRTA OY / VIRTA LTD, Helsinki (FI)

(72) Inventor: Jussi AHTIKARI, Helsinki (FI)

(73) Assignee: LIIKENNEVIRTA OY / VIRTA LTD, Helsinki (FI)

(21) Appl. No.: 18/694,209

(22) PCT Filed: Sep. 19, 2022
(86) PCT No.: PCT/FI2022/050626

§ 371 Date: Mar. 21, 2024

(30) Foreign Application Priority Data
Sep. 21, 2021 (FI) 20215987

(51) Int. Cl. B60L 53/68; B60L 53/62

(52) U.S. Cl. CPC B60L 53/68; B60L 53/62

(57) ABSTRACT

Various example embodiments generally relate to charging electric devices. An apparatus may comprise: means for determining a target amount of energy to be charged to an electric device; means for receiving, from a charging station, a charging report associated with a current reporting interval; means for estimating a remaining charging time based on at least the charging report associated with the current reporting interval and the target amount of energy; means for setting a maximum charging rate for a subsequent reporting interval, in response to determining that the remaining charging time is lower than or equal to a threshold; and means for transmitting an indication of the maximum charging rate to the charging station.

### TECHNICAL FIELD

Various example embodiments generally relate to the field of charging electric devices. Some example embodiments relate to accurately delivering a target amount of energy to an electric vehicle.

### BACKGROUND

Popularity of electric vehicles (EV) is increasing rapidly and therefore also demand for charging EVs is increasing. Charging stations may be connected to a remote charging controller to enable centralized management of charging operations. In various applications it may be desired to stop charging when a predetermined energy limit has been reached.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure improve accuracy of delivering a target amount of energy to an electric device. This and other benefits may be achieved by the features of the independent claims. Further implementation forms are provided in the dependent claims, the description, and the drawings.

According to a first aspect, an apparatus comprises means for determining a target amount of energy to be charged to an electric device; means for receiving, from a charging station, a charging report associated with a current reporting interval; means for estimating a remaining charging time based on at least the charging report associated with the current reporting interval and the target amount of energy; means for setting a maximum charging rate for a subsequent reporting interval, in response to determining that the remaining charging time is lower than or equal to a threshold; and means for transmitting an indication of the maximum charging rate to the charging station.

According to an example embodiment of the first aspect, the apparatus further comprises: means for determining a charge stop time based on the remaining charging time; and means for transmitting a stop charging command to the charging station, in response to reaching the charge stop time, or means for transmitting an indication of the charge stop time to the charging station.

According to an example embodiment of the first aspect, the apparatus further comprises: means for receiving a charging report associated with a previous reporting interval comprising an indication of a first amount of energy charged to the electric device at an end of the previous reporting interval, wherein the charging report associated with the current reporting interval comprises an indication of a second amount of energy charged to the electric device at an end of the current reporting interval; means for determining a charging rate of the current reporting interval based on the first amount of energy, the second amount of energy, and a length of the current reporting interval; means for estimating the remaining charging time based on the second amount of energy, the charging rate of the current reporting interval, and the target amount of energy.

According to an example embodiment of the first aspect, the charging report comprises an indication of an amount of energy charged to the electric device during the current reporting interval, and the apparatus further comprises: means for determining a charging rate of the current reporting interval based on the amount of energy charged during the current reporting interval and a length of the current reporting interval; and means for estimating the remaining charging time based on an amount of energy charged to the electric device at an end of a previous reporting interval, the charging rate of the current reporting interval, and the target amount of energy.

According to an example embodiment of the first aspect, the maximum charging rate is substantially equal to the charging rate of the current reporting interval.

According to an example embodiment of the first aspect, the threshold is dependent on the length of the current reporting interval.

According to an example embodiment of the first aspect, the threshold is proportional to the length of the current reporting interval.

According to an example embodiment of the first aspect, the threshold is configurable.

According to an example embodiment of the first aspect, the threshold is configurable based on a difference between at least one target amount of energy and at least one reported amount of energy of at least one previous charging transaction.

According to an example embodiment of the first aspect, the threshold comprises an integer multiple of the length of the current reporting interval.

According to an example embodiment of the first aspect, the threshold is substantially equal to five times the length of the current reporting interval.

According to an example embodiment of the first aspect, the apparatus further comprises: means for determining an adjusted length for the subsequent reporting interval, wherein the adjusted length of the subsequent reporting interval is shorter than a length of the current reporting interval; and means for transmitting an indication of the adjusted length of the subsequent reporting interval to the charging station.

According to an example embodiment of the first aspect, the apparatus further comprises: means for determining the adjusted length of the subsequent reporting interval, in response to determining that the remaining charging time is lower than or equal to the threshold.

According to an example embodiment of the first aspect, the adjusted length of the subsequent reporting interval is dependent on the remaining charging time.

According to an example embodiment of the first aspect, the adjusted length of the subsequent reporting interval is proportional to the remaining charging time.

According to an example embodiment of the first aspect, the adjusted length of the subsequent reporting interval is substantially half of the current reporting interval.

According to an example embodiment of the first aspect, the apparatus further comprises: means for determining the adjusted length of the subsequent reporting interval, in response to determining that the charging station supports dynamic adjustment of reporting interval.

According to an example embodiment of the first aspect, the electric device comprises an electric vehicle.

According to a second aspect, a method comprises: determining a target amount of energy to be charged to an electric device; receiving, from a charging station, a charging report associated with a current reporting interval; estimating a remaining charging time based on at least the charging report associated with the current reporting interval and the target amount of energy; setting a maximum charging rate for a subsequent reporting interval, in response to determining that the remaining charging time is lower than or equal to a threshold; and transmitting an indication of the maximum charging rate to the charging station.

According to an example embodiment of the second aspect, the method further comprises: determining a charge stop time based on the remaining charging time; and transmitting a stop charging command to the charging station, in response to reaching the charge stop time, or transmitting an indication of the charge stop time to the charging station.

According to an example embodiment of the second aspect, the method further comprises: receiving a charging report associated with a previous reporting interval comprising an indication of a first amount of energy charged to the electric device at an end of the previous reporting interval, wherein the charging report associated with the current reporting interval comprises an indication of a second amount of energy charged to the electric device at an end of the current reporting interval; determining a charging rate of the current reporting interval based on the first amount of energy, the second amount of energy, and a length of the current reporting interval; estimating the remaining charging time based on the second amount of energy, the charging rate of the current reporting interval, and the target amount of energy.

According to an example embodiment of the second aspect, the charging report comprises an indication of an amount of energy charged to the electric device during the current reporting interval, and the method further comprises: determining a charging rate of the current reporting interval based on the amount of energy charged during the current reporting interval and a length of the current reporting interval; and estimating the remaining charging time based on an amount of energy charged to the electric device at an end of a previous reporting interval, the charging rate of the current reporting interval, and the target amount of energy.

According to an example embodiment of the second aspect, the maximum charging rate is substantially equal to the charging rate of the current reporting interval.

According to an example embodiment of the second aspect, the threshold is dependent on the length of the current reporting interval.

According to an example embodiment of the second aspect, the threshold is proportional to the length of the current reporting interval.

According to an example embodiment of the second aspect, the threshold is configurable.

According to an example embodiment of the second aspect, the threshold is configurable based on a difference between at least one target amount of energy and at least one reported amount of charged energy of at least one previous charging transaction.

According to an example embodiment of the second aspect, the threshold comprises an integer multiple of the length of the current reporting interval.

According to an example embodiment of the second aspect, the threshold is substantially equal to five times the length of the current reporting interval.

According to an example embodiment of the second aspect, the method further comprises: determining an adjusted length for the subsequent reporting interval, wherein the adjusted length of the subsequent reporting interval is shorter than a length of the current reporting interval; and transmitting an indication of the adjusted length of the subsequent reporting interval to the charging station.

According to an example embodiment of the second aspect, the method further comprises: determining the adjusted length of the subsequent reporting interval, in response to determining that the remaining charging time is lower than or equal to the threshold.

According to an example embodiment of the second aspect, the adjusted length of the subsequent reporting interval is dependent on the remaining charging time.

According to an example embodiment of the second aspect, the adjusted length of the subsequent reporting interval is proportional to the remaining charging time.

According to an example embodiment of the second aspect, the adjusted length of the subsequent reporting interval is substantially half of the current reporting interval.

According to an example embodiment of the second aspect, the method further comprises: determining the adjusted length of the subsequent reporting interval, in response to determining that the charging station supports dynamic adjustment of reporting interval.

According to an example embodiment of the second aspect, the electric device comprises an electric vehicle.

According to a third aspect, a computer program or computer program product comprises program code configured to, when executed by an apparatus, cause the apparatus at least to: determine a target amount of energy to be charged to an electric device; receive, from a charging station, a charging report associated with a current reporting interval; estimate a remaining charging time based on at least the charging report associated with the current reporting interval and the target amount of energy; set a maximum charging rate for a subsequent reporting interval, in response to determining that the remaining charging time is lower than or equal to a threshold; and transmit an indication of the maximum charging rate to the charging station. The computer program or the computer program product may be further configured, when executed by the apparatus, to cause the apparatus to perform a method according to any example embodiment of the second aspect.

According to a fourth aspect an apparatus may comprise at least one processor; and at least one memory including computer program code; the at least one memory and the computer program code configured to, with the at least one processor, cause the apparatus at least to: determine a target amount of energy to be charged to an electric device; receive, from a charging station, a charging report associated with a current reporting interval; estimate a remaining charging time based on at least the charging report associated with the current reporting interval and the target amount of energy; set a maximum charging rate for a subsequent reporting interval, in response to determining that the remaining charging time is lower than or equal to a threshold; and transmit an indication of the maximum charging rate to the charging station. The computer program code may be further configured, when executed by the apparatus, to cause the apparatus to perform a method according to any example embodiment of the second aspect.

It is appreciated that the example embodiments described above may be used in combination with each other. Several of the example embodiments may be combined to form a further example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a charging system, according to one or more example embodiments;

FIG. 2 illustrates an example of an apparatus configured to practice one or more example embodiments;

FIG. 3 illustrates examples of charging power curves, according to one or more example embodiments;

FIG. 4 illustrates an example of determining a maximum charging rate, according to one or more example embodiments;

FIG. 5 illustrates an example of a dynamic adjustment of a reporting interval, according to one or more example embodiments;

FIG. 6 illustrates an example of a message sequence and operations for determining a maximum charging rate and a charging stop time, according to one or more example embodiments; and

FIG. 7 illustrates an example of a message sequence and operations for determining a maximum charging rate, adjusting a reporting interval, and determining a charging stop time, according to one or more example embodiments; and

FIG. 8 illustrates an example of a method for controlling charging of an electric device, according to one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

A charging station may be connected to a remote charging controller to enable centralized control of charging operations. The remote charging controller may be for example configured to control the amount of energy delivered to an electric device, for example by sending a stop charging command to the charging station at an appropriate time. In various applications it may be desired to provide a predetermined target amount of energy to the electric device as accurately as possible.

According to an example embodiment, a remote charging controller may determine a target amount of energy to be charged to an electric device. The remote charging controller may receive, from a charging station, a charging report associated with a current reporting interval. Based on the charging report and the target amount of energy, the remote charging controller may estimate the remaining charging time for the electric device. The remote charging controller may set a maximum charging rate for at least one subsequent reporting interval, in response to determining that the remaining charging time meets a condition. An indication of the maximum charging rate may be transmitted to the charging station, which may control charging of the electric device accordingly. This enables to terminate charging without exceeding the target amount of energy. Length of the reporting interval may be dynamically adjusted to improve accuracy of delivering the target amount of energy to the electric device.

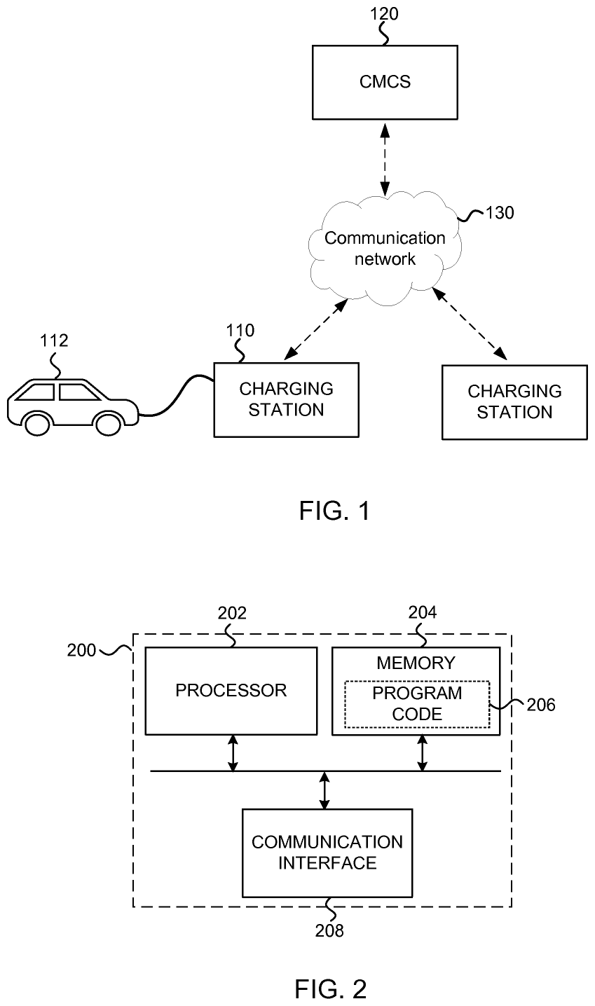

FIG. 1 illustrates an example of a charging system. Charging system 100 may comprise a charging station 110. Charging station 110 may comprise one or more charging connectors for charging electric device(s), for example an electric vehicle (EV) 112. A charging connector may be considered as electric vehicle supply equipment (EVSE). In general, EVSE may comprise an independently operated and managed part of the charging station 110 that is configured to deliver energy to one electric vehicle at a time.

Charging system 100 may further comprise a remote charging controller, represented in this example by charging station management system (CSMS) 120. CSMS 120 may be configured to control charging operations of one or more charging stations. CSMS 120 may comprise a server. CSMS 120 may be communicatively coupled to charging station 110 via a communication network 130, for example a wireless or wired Internet connection. CSMS 120 may be however located remote from charging station 110. Even though CSMS 120 has been illustrated as a single device, it is appreciated that functionality of CSMS 120 may be distributed to a plurality of devices, or in general implemented by any suitable means, for example as a cloud computing service.

Charging system 100 may also comprise other charging station(s). CSMS 120 may be therefore configured control multiple charging stations, which may be located at different geographical locations. Charging system 100 may be configured in accordance with or based on a standard, for example the open charging point protocol (OCPP), which may define a communication protocol between charging station 110 and CSMS 120. It is however appreciated that the example embodiments may be applied in any other current or future electric device charging systems, including both standardized and proprietary systems. It is also noted that the example embodiments may be applied to any type of electric vehicles, such as for example electric boats or motorcycles, or any other electric devices, for example mobile phones or tablets.

In various applications it may be desired to stop charging automatically after reaching a certain energy limit. For example, a store may provide its customers with a certain amount free energy (e.g. 10 kWh) when shopping at the store. Charging stations connected to local energy storages may be configured to provide a certain amount of energy that is available at the local energy storage. End customers may also use prepaid payments, for example a prepaid payment of 20 EUR for 80 kWh of energy. Once the energy limit is reached, the charging may be configured to stop automatically. CSMS 120 may control when charging station 110 stops charging electric vehicle 112.

Charging station 110 may transmit charging reports to CSMS 120. A charging report may be associated with a reporting interval. A charging report may for example include information gathered during the associated reporting interval or at the end of the reporting interval. Charging reports may be sent periodically with regular reporting intervals, for example once a minute. Alternatively, the duration of the reporting interval may be dynamically adjusted during the charging.

A charging report may comprise an indication of the amount of energy charged to electric vehicle 112 until a particular time, for example the end of the associated reporting interval. The charging report may therefore indicate how much energy has been used so far for charging electric vehicle 112. The charging report may comprise a signaling field (e.g. meterValue) indicative of the amount of energy charged, optionally with a time stamp of this energy measurement. The charging report may further comprise a connector identifier that identifies the connector or the main power meter of the charging station associated with the energy measurement. The charging report may further comprise a transaction identifier, indicating which charging transaction the reported energy measurement is associated with. CSMS 120 may use the received charging reports to estimate when a target amount of energy is reached and to cause termination of the charging at an appropriate time. The target amount of energy may comprise a maximum limit for the energy to be charged to electronic vehicle 112, expressed for example in kWh.

Alternatively, or additionally, a charging report may comprise an indication of an amount of energy charged to electric vehicle 112 during the associated reporting interval. In general, the charging reports may comprise any suitable type of information that enables CSMS 120 to monitor the cumulative amount of energy charged to electric vehicle 112 from the beginning of the charging to the end of the associated reporting interval and to determine the amount of energy charged during the associated reporting interval. For example, if a charging report associated with a current reporting interval does not indicate the amount of energy charged during the current reporting interval, CSMS 120 may determine the amount of energy charged during the current reporting interval based on cumulative amounts of charged energy indicated at charging reports associated with a previous reporting interval and the current reporting interval. If the charging reports do not indicate the cumulative amount of energy, CSMS 120 may calculate the cumulative amount of energy by summing the amounts of energy charged during the previous reporting intervals to obtain the cumulative amount of energy.

As noted above, it may be desired to set a charge stop time such that the target amount of energy is provided to electric vehicle 112 as accurately as possible. For example, if a customer has paid for 50.0 kWh of energy, providing more than the paid amount of energy (e.g. 50.1 kWh) may cause a loss of profit for the provider of the charging service. Even if the difference were small, the deviation from the target amount may add up to a considerable amount when considering a large number (e.g. millions) of charging transactions.

CSMS 120 may use the charging reports to follow how much energy has been charged to electric vehicle 112. If the charging reports are received with one-minute intervals, CSMS 120 is informed about the cumulative amount of energy charged so far after each full minute. However, in order to enable accurate delivery of the target amount of energy to electric vehicle 112, CSMS 120 should be able to calculate when exactly charging station 110 should stop charging electric vehicle 112.

For example, let's assume that charging station 110 transmits charging reports once a minute and a customer should get exactly 50.0 kWh of energy. A first charging report may indicate to CSMS 120 that the customer has been charging for 49.8 kWh. Hence, CSMS 120 may determine not to request charging station 110 to stop the charging yet. A second charging report received one minute later may indicate that the customer has now charged 50.2 kWh. At this point, the target amount of 50.0 kWh has been exceeded and CSMS 120 is not able to stop the charging in time. To achieve the target amount of 50.0 kWh, the charge stop time should be somewhere between the two charging reports.

One approach for improving accuracy of charging is to monitor the target amount of energy locally at charging station 110, and not by CSMS 120. In this case, charging station 110 may receive real time information from a local energy meter residing at charging station hardware, which enables charging station 110 to stop charging locally when the target amount of energy is reached. However, no standardized solution exists for this local monitoring based approach and therefore not all charging stations may support this feature. Other solutions may be therefore needed if it is desired to operate charging system 100 with different charging station models. It may be therefore desired to improve accuracy of the remote termination of charging controlled by CSMS 120. This may be implemented in compliance with existing standards (e.g. OCPP) and therefore the disclosed automatic remote stop functionality may be applied with all the hundreds of different charging station models in the market.

FIG. 2 illustrates an example embodiment of an apparatus configured to practice one or more example embodiments. Apparatus 200 may comprise a computing device such as for example a server. Although apparatus 200 is illustrated as a single device it is appreciated that, wherever applicable, functions of apparatus 200 may be distributed to a plurality of devices, for example to implement functionality of the apparatus as a cloud computing service.

Apparatus 200 may comprise at least one processor 202. At least one processor 202 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. At least one memory 204 may be configured to store, for example, computer program code or the like, for example operating system software and application software. At least one memory 204 may comprise one or more volatile memory devices, one or more non-volatile memory devices, and/or a combination thereof. For example, at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable the apparatus 200 to transmit and/or receive information, to/from other apparatuses. Communication interface 208 may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or in general any wired Internet connection. Communication interface 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas. Communication interface 208 may also comprise an internal communication interface within a system, such as for example a data bus. In general, communication interface 208 may comprise circuitry (e.g. transmitter and/or receiver circuitry) for communicating over the communication network 130. Communication interface 208 may be configured to support at least one charging protocol, for example OCPP.

When apparatus 200 is configured to implement some functionality, some component and/or components of apparatus 200, such as for example at least one processor 202 and/or at least one memory 204, may be configured to implement this functionality. Furthermore, when at least one processor 202 is configured to implement some functionality, this functionality may be implemented using program code 206 comprised, for example, in at least one memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs). Apparatus 200 therefore comprises means for performing at least one example embodiment described herein. Apparatus 200 may used to implement CSMS 120 or charging station 110.

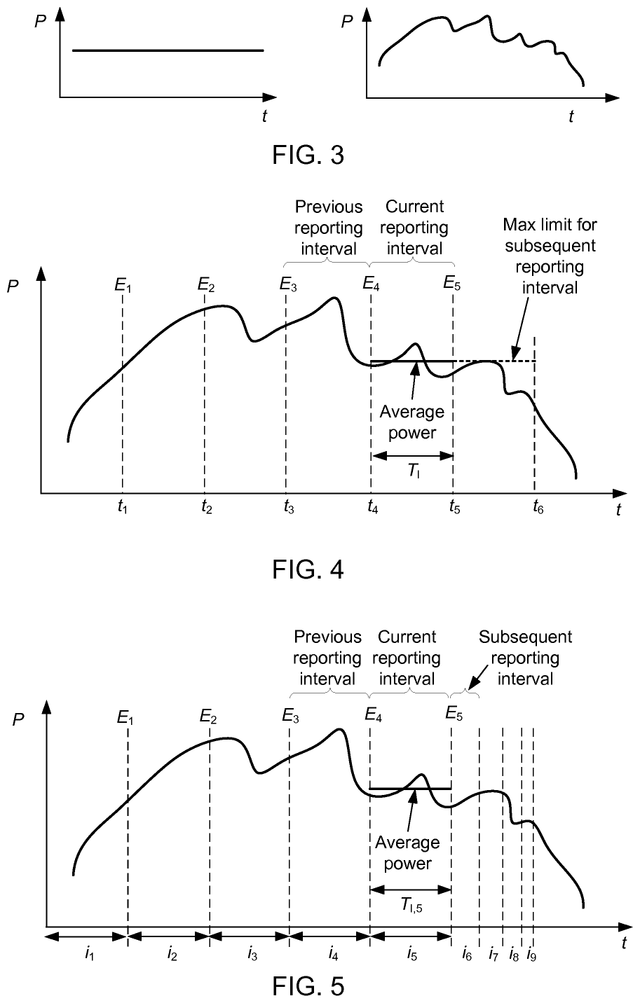

FIG. 3 illustrates examples of charging power curves. On the left is an example of a charging power curve with constant charging power (P) over time (t). Assuming such a power curve enables simple estimation of the remaining charging time. For example, let's assume it is desired to provide exactly 50 kWh to a customer. The customer has been charging for 10 minutes and has got so far 45 kWh. Assuming the constant power charging curve, CSMS 120 may calculate that the average charging rate, in this example energy per minute, has been 45 kWh/10 min=4.5 kWh/min. Based on this CSMS 120 may calculate that there is 50 kWh−45 kWh=5 kWh left to be provided for the customer. With the charging rate of 4.5 kWh/min it may be estimated to take 5/4.5=1.11 minutes until the target amount of 50 kWh is reached. A charge stop time may be therefore set to be 1.11 min ahead, for example 1.11 min from the time stamp of the latest charging report. CSMS 120 may for example initiate an automatic timer at 1.11 minutes and send a stop charging command to charging station 110 when the timer has expired.

However, in practise the charging power curve may not be constant, as illustrated on the right. In this type of situation the assumption of constant power curve may cause the charge stop time to be set inaccurately and the amount of charged energy to be significantly different from the target amount. Example embodiments of the present disclosure therefore improve determining a charge stop time for accurately delivering a desired amount of energy to an electric device.

FIG. 4 illustrates an example of determining a maximum charging rate. CSMS 120 may initially determine a target amount of energy E_{target} for electric vehicle 112. CSMS 120 may receive charging reports (e.g. meterValues) with regular reporting intervals, for example at time instants tₙ. The charging reports may indicate the cumulative amount of energy Eₙ charged to electric vehicle 112. This amount of energy may be counted from the beginning of the charging. Alternatively, charging station 110 may inform CSMS 120 about an initial value of the charged energy (e.g. initial meterValue) such that CSMS 120 is enabled to calculate the amount of energy charged based on the difference of the reported amount of energy and the initial amount of energy. These two examples may be seen as alternatives for indicating the cumulative amount of energy charged to electric vehicle 112. Furthermore, as noted above, it is also possible to indicate the amount of energy charged by indicating the amount of energy charged during the respective reporting intervals.

The lengths of the reporting intervals between consecutive time instants tₙ₋₁ and tₙ may be identical (T_{I}). At time instant t₅, the reporting interval t₄ to t₅ may be considered as the current reporting interval. From the perspective of CSMS 120, the current reporting interval may therefore comprise the latest reporting interval for which a charging report has been received from charging station 110. At time t₅, the reporting interval t₃ to t₄ may be referred to as a previous reporting interval. The previous reporting interval may therefore directly precede the current reporting interval in time, i.e., the current reporting interval may be the next reporting interval after the previous reporting interval.

When the charging report is received at time instant t₅, CSMS 120 may determine the charging rate (e.g. energy per minute) used in the current reporting interval. CSMS 120 may for example compare the amounts of charged energy indicated at the end of the previous reporting interval (t₄) and at the end of the current reporting interval (t₅) and calculate an average charging power based on these amounts of energy and the length of the current reporting interval. For example, considering t₅ as the current time, the average charging power of the current reporting interval may be calculated by

$$\frac{{E}_{5} - {E}_{4}}{{T}_{I}}$$

where T₁ is the length of the reporting interval, that is, the time between time instants t₅ and t₄, or in general tₙ₋₁ and tₙ. Alternatively, the average charging power may be calculated based on dividing the energy charged during the current reporting interval by the length of the current reporting interval. The average charging power is an example of a charging rate. Based on the determined charging rate, CSMS 120 may estimate the remaining charging time until reaching the target amount of energy. If reaching the target amount of energy is close, for example less than five reporting intervals away, CSMS 120 may set a limit for the charging power of the subsequent reporting interval, for example to the average power of the current reporting interval. This enables to guarantee that electric vehicle 112 does not take more energy than assumed in the estimation of the remaining charging time. CSMS 120 may then set a charge stop time (e.g. initiate a stop timer) based on the estimate of the remaining charging time. In general, CSMS 120 may set a maximum charging rate for the subsequent reporting interval. The maximum charging rate may be also referred to as a maximum allowed charging rate and it may define an upper limit for the charging rate of electric vehicle 112. The maximum charging rate may be expressed for example in terms of charging power or charging current. The subsequent reporting interval may directly follow the current reporting interval in time, i.e., the subsequent reporting interval may be the next reporting interval after the current reporting interval. However, the maximum charging rate may be generally set for one or more subsequent reporting intervals, which may or may not directly follow the current reporting interval in time.

When CSMS 120 receives a charging report at time tₙ, CSMS 120 may subtract the amount of energy Eₙ indicated in the current charging report from the target amount of energy E_{target} to determine the amount of remaining energy to be charged:

$${E}_{remaining} = {E}_{target} - {E}_{n} .$$

CSMS 120 may calculate the charging rate of the current reporting interval, for example as the energy-per-minute rate Eₘᵢₙᵤₜₑ, based on the difference between the amounts of energy indicated in the current (Eₙ) and previous (Eₙ₋₁) charging reports and the length of the current reporting interval. CSMS 120 may for example calculate

$${E}_{minute} = \frac{{E}_{n} - {E}_{n - 1}}{{T}_{I}} .$$

The charging rate of the current reporting interval may be therefore calculated by subtracting the previous amount of charged energy from the current amount of charged energy and dividing the result by the length of the current reporting interval.

CSMS 120 may estimate the remaining charging time t_{remaining} based on the remaining amount of energy E_{remaining} and the charging rate Eₘᵢₙᵤₜₑ of the current reporting interval. CSMS 120 may for example calculate

$${t}_{remaining} = \frac{{E}_{remaining}}{{E}_{minute}} .$$

CSMS 120 may determine the number of remaining reporting intervals based on the estimate of the remaining charging time and the length of the reporting intervals, for example by t_{remaining}/T₁. If the number of remaining reporting intervals is lower (or equal to) a threshold, for example five reporting intervals, CSMS 120 may determine to limit the charging rate for subsequent reporting intervals, for example by setting a power limit Pₗᵢₘᵢₜ. CSMS 120 may send a command to charging station 110 to limit the charging power to Pₗᵢₘᵢₜ. CSMS 120 may send the command to cause the charging rate of electric vehicle 112 to be limited to Pₗᵢₘᵢₜ. The charging rate may be limited to the average charging power used by electric vehicle 112 during the current interval. The charging power limit may be calculated for example by Pₗᵢₘᵢₜ=Eₘᵢₙᵤₜₑ×60 min.

CSMS 120 may set the charge stop time to tₛₜₒₚ=tₙ+t_{remaining}. The charge stop time may be updated each time a new charging report is received from charging station 110. When the charge stop time is reached, CSMS 120 may send a stop charging command, for example RemoteStopTransaction command of OCPP, to charging station 110 to cause termination of the charging.

As a numerical example, let's assume that it is desired to provide exactly 50.0 kWh to electric vehicle 112 of a customer and therefore the target amount of energy is 50.0 kWh. The customer has been charging electric vehicle 112 for 10 minutes and so far got 45.0 kWh. The average charging rate over the elapsed charging time has been therefore 4.5 kWh/min. CSMS 120 may determine the charging rate of the current reporting interval based on the latest charging report received. Let's assume that the length of the current reporting interval was one minute and the amount of energy charged during the current reporting interval was 2 kWh. The charging power during the latest reporting interval was therefore lower than the average power over the elapsed charging time. Based on the charging power of the current reporting interval, CSMS 120 may determine a more accurate estimate for the remaining charging time, for example by 5 kWh/2 kWh/min=2.5 min, and set a new charge stop time accordingly.

After another one-minute reporting interval, CSMS 120 may perform similar estimation again. Assuming that 2.2 kWh has been charged during the last reporting interval, which may be now considered as the current reporting interval, the total amount of charged energy becomes 45 kWh+2.2 kWh=47.2 kWh and there is 2.8 kWh missing from the target amount of 50 kWh. Based on the average charging rate of 2.2 kWh/min, CSMS 120 may estimate the remaining charging time to be 2.8 kWh/2.2 kWh/min=1.27 min to reach the target amount of 50.0 kWh. CSMS 120 may then update the charge stop time accordingly. This process may be iterated until the remaining charging time is smaller than the reporting interval and the charge stop time may be set to occur before expiry of the last reporting interval.

However, even if CSMS 120 estimates the remaining charging time based on the assumption that the charging rate of the subsequent reporting interval does not exceed the charging rate of the current interval (2.2 kWh), it is possible that the electric vehicle 112 charges with higher power. This may be avoided by setting the maximum charging rate for the subsequent reporting interval. This ensures that the total amount of charged energy does not exceed the target amount of 50 kWh. The maximum charging rate may be set when the remaining charging time is below or equal to a threshold (e.g. less than five reporting intervals away). This allows electric vehicle 112 to freely charge at any desired charging rate until being close to the target amount.

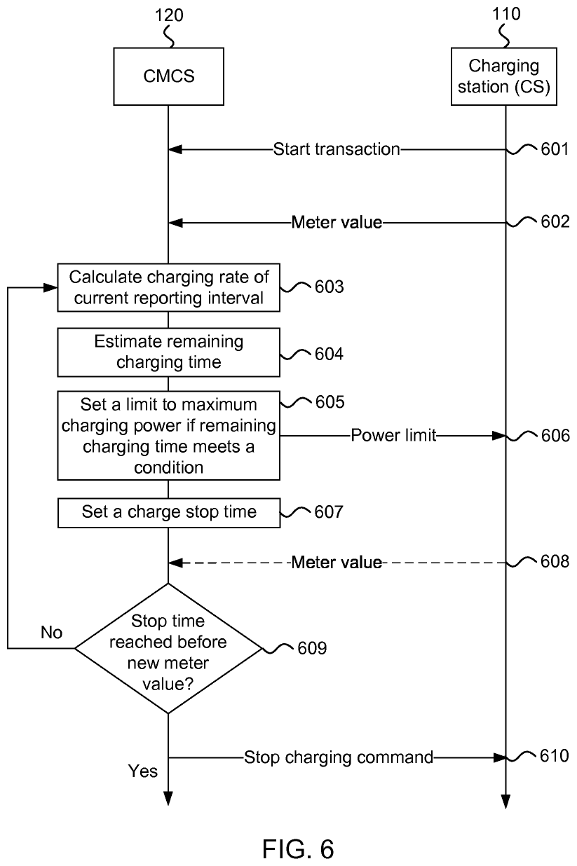

Continuing the above numerical example, the charging rate of the latest reporting interval was 2.2 kWh/min, which is equivalent to charging power of 132 kW. Based on the charging rate the stop timer may be set to 1.27 min. The target amount of 50 kWh is therefore relatively close. CSMS 120 may send a command to charging station 110 to set the maximum charging power to 132 kW. This ensures that the estimation of the remaining charging time is more accurate, because charging station 110 does not take more than the estimated 2.2 kWh during the next reporting interval. If the electric vehicle 112 would raise the charging power, for example to 140 kW, the estimation of the remaining charging time would be less accurate. Limiting the charging power to 132 kW enables to estimate the remaining charging time such that the target amount of 50 kWh is not exceeded. And, in case charging station 110 would take less energy (i.e. lower than the 132 kW limit) during the subsequent reporting interval, CSMS 120 may again update the maximum charging power for further reporting interval(s). Determining the maximum charging rate is further described with reference to FIG. 6.

Setting a maximum charging rate based on the charging rate of the latest reporting interval enables more accurate estimation of the remaining charging time compared to using the assumption of constant charging power over the entire charging time. While this approach may be implemented with modest complexity increase, accuracy of delivering the target amount of energy may be further improved, as described below.

In the above numerical example, CSMS 120 determined that there was 2.8 kWh left until reaching the target of 50 kWh and that the charging rate of the latest reporting interval was 2.2 kWh/min. Hence, the stop timer was set to 1.27 min. The charging rate of the subsequent reporting interval was also limited to ensure the target amount of 50 kWh is not exceeded. However, let's assume that the stop timer would expire before the end of the subsequent one-minute reporting interval, for example after 0.8 minutes. Let's also assume that instead of charging with 2.2 kWh/min, the electric vehicle 112 would drop charging power to 1.1 kWh/min. In this case, CSMS 120 would determine to stop the charging too early, before reaching the target amount of 50 kWh. Furthermore, CSMS 120 may detect this only after receiving the next charging report (meterValue) when the charging has already stopped. This issue may be alleviated by having shorter reporting intervals, for example an interval of one second instead of one minute. This may however create a huge amount of data traffic between charging station 110 and CSMS 120, thereby also resulting in huge data transfer costs. And, assuming for example charging of 100 kWh in 30 min, it may be unnecessary to provide charging reports with such a short interval at the beginning of the charging, since it is clear that the target amount of 100 kWh is not going to be reached very soon. It may be therefore desired to adjust the length of the reporting interval during the charging, as will be further described below.

FIG. 5 illustrates an example of a dynamic adjustment of a reporting interval. CSMS 120 may receive charging reports with regular reporting intervals i₁ to i₅. The lengths of these reporting intervals may be identical, for example one minute. After each reporting interval iₙ, CSMS 120 may receive an indication of the amount of energy Eₙ charged to electric vehicle 112 over the elapsed charging time (cumulative amount of energy). Considering reporting interval i₅ as the current reporting interval, reporting intervals i₄ and i₆ may be referred to as the previous and subsequent reporting intervals, respectively. In response to receiving the charging report at the end of the current reporting interval i₅, CSMS 120 may determine the charging rate of the current reporting interval. CSMS 120 may for example compare the amounts of energy indicated at the end of the previous reporting interval (E₄) and at the end of the current reporting interval (E₅) and calculate an average charging power based on these amounts of energy and the length of the current reporting interval (T_{I,5}), as described above. Based on the determined charging rate CSMS 120 may estimate the remaining charging time until reaching the target amount of energy. If reaching the target amount of energy is close, for example less than five times the current reporting interval, CSMS 120 may determine to shorten the reporting interval and transmit an indication of the shortened reporting interval to charging station 110. As illustrated in FIG. 5, the subsequent reporting interval i₆ is shorter than the current reporting interval i₅.

After reporting interval i₆, the procedure may be repeated such that charging rate of reporting interval i₆ (now the current reporting interval) is estimated and the length of the subsequent reporting interval i₇ is shortened, if the remaining charging time is lower than a threshold (e.g. five times the length of interval i₆). The length of the reporting interval may be thus dynamically adjusted. Shortening the reporting interval when approaching the target amount enables to improve accuracy of charging the target amount of energy to electric vehicle 112.

At the beginning of charging, CSMS 120 may determine the target amount of energy E_{target}. CSMS 120 may further check the maximum charging power Pₘₐₓ of charging station 110. CSMS 120 may initially estimate the total charging time t_{charge} based on the target amount of energy and the maximum charging power of charging station 110. To obtain the total charging time in minutes, CSMS 120 may for example calculate

$${t}_{charge} = \frac{{E}_{target}}{60 {P}_{max}} .$$

CSMS 120 may initially set the length of the reporting interval to be a fraction of the estimated total charging time, for example t_{charge}/10. CSMS 120 may transmit an indication of this initial reporting interval to charging station 110. Charging station 110 may configure transmission of the charging reports accordingly. The first charging report may be therefore received for example when 10% of the estimated total charging time has elapsed.

When CSMS 120 receives a charging report associated with a current reporting interval iₙ, the report comprising an indication of the amount of energy Eₙ charged to electric vehicle 112 at the end of the current reporting interval, CSMS 120 may determine a charging rate for the current reporting interval. CSMS 120 may further estimate the remaining charge time, set a charge stop time, and set a maximum charging rate for the subsequent reporting interval if the remaining charging time is lower (or equal to) a threshold, as described above.

CSMS 120 may determine the number of remaining reporting intervals by

$${I}_{remaining} = \frac{{t}_{remaining}}{{T}_{I , n}} ,$$

where T_{I,n} denotes the length of the currenet (n-th) reporting interval iₙ. If the number of remaining reporting intervals is lower (or equal to) a threshold, for example if I_{remaining}<5, CSMS 120 may determine to decrease the length of the reporting interval. For example, CSMS 120 may determine an adjusted length for the reporting interval such that the length of the subsequent reporting interval is half of the current interval, that is, T_{I,n+1}=T_{I,n}/2. In general, the length of the reporting interval may be adjusted such that the length of the subsequent reporting interval is dependent on, for example proportional to, the length of the current reporting interval. CSMS 120 may transmit an indication of the adjusted reporting interval to charging station 110. Charging station 110 may configure transmission of the charging reports accordingly. Charging reports may be therefore subsequently received more often compared to the current reporting interval.

Charging station 110 may be configured with a minimum allowed reporting interval. When determining the adjusted reporting interval, CSMS 120 may check that the adjusted reporting interval is longer or equal to the minimum allowed reporting interval. For example, if CSMS 120 determines the length of the adjusted reporting interval to be shorter than the minimum allowed reporting interval, CSMS 120 may set the length of the adjusted reporting interval to be equal to the minimum allowed reporting interval.

As a numerical example, let's assume the target amount of energy is 100 kWh and charging is started with a five-minute reporting interval. After the first five minutes CSMS 120 may determine that electric vehicle 112 has been charged with 5 kWh, corresponding to charging rate of 1 kWh/min. Based on this charging rate CSMS 120 may estimate that the remaining charging time is 95 min, corresponding to nineteen five-minute reporting intervals to reach the target amount of 100 kWh. CSMS 120 may therefore determine to continue with the five-minute reporting intervals for a while. Let's further assume that after 30 min the amount of energy charged to electric vehicle 112 is 60 kWh. The average charging rate over the entire elapsed charging time has therefore increased from 1 kWh/min to 2 kWh/min. During the last five-minute reporting interval the charging energy has been 15 kWh, corresponding to 3 kWh/min charging rate. Based on this charging rate, CSMS 120 may estimate the remaining charging time to be (100 kWh−60 kWh)/3 kWh/min=13.3 min until the target amount of 100 kWh is reached. The remaining charging time is therefore slightly lower than three five-minute reporting intervals. Assuming a threshold of five reporting intervals, CSMS 120 may determine to shorten the reporting interval, for example to one minute, in order to monitor progress of the charging more frequently.

After receiving the next charging report at 31 minutes, CSMS 120 may determine that 63.1 kWh has been charged in total and hence the charging rate of the last one-minute reporting interval was 3.1 kWh/min. The remaining amount of energy to be charged is 36.9 kWh and with the one-minute reporting interval this corresponds to 36.9/3.1=11.9 reporting intervals. CSMS 120 may therefore determine to continue with the one-minute reporting interval.

Let's further assume that after a while the amount of charged energy is 90 kWh and that the charging rate of the last one-minute interval was 3.3 kWh/min. CSMS 120 may then estimate that the remaining charging time is (100 kWh−90 kWh)/3.3 kWh/min=3.33 min, corresponding to less than four one-minute reporting intervals. Again, CSMS 120 may determine to shorten the reporting interval, for example to 10 seconds.

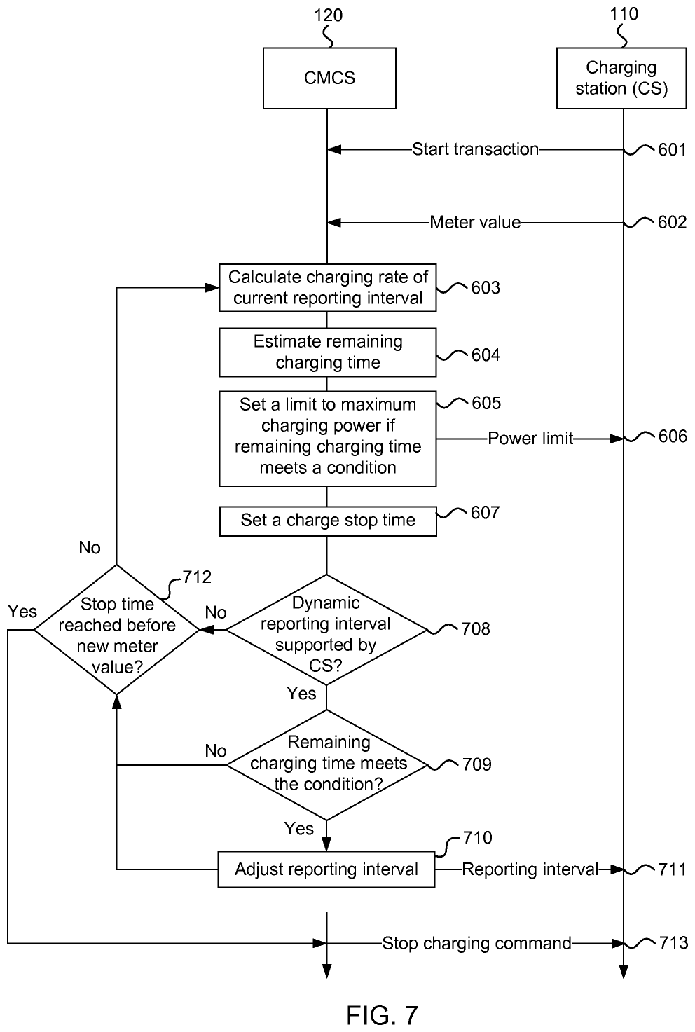

The process may be iterated such that after receiving each charging report CSMS 120 calculates the average charging power of the current reporting interval and based on that estimates the remaining charging time. If the remaining charging time is lower than a threshold, where the threshold may be dependent on the length of the current reporting interval, CSMS 120 may determine to update the reporting interval to have a shorter duration. Since the charging reports are subsequently received at a shorter and shorter reporting intervals, the accuracy of the estimation of the charge stop time improves until the target amount of energy is reached. The dynamic adjustment of the reporting interval may be also combined with setting the maximum charging rate for the subsequent reporting interval, as will be further described with reference to FIG. 7.

FIG. 6 illustrates an example of a message sequence and operations for determining a maximum charging rate and a charging stop time.

At operation 601, CSMS 120 may receive a start transaction message from charging station 110. The start transaction message may be transmitted by charging station 110 to inform CSMS 120 about a charging transaction that has been started. The start transaction message may comprise an identifier of a connector of charging station 110 associated with the started charging transaction. The start transaction message may comprise a meter value indicative of the initial amount of charged energy for the connector. In some example embodiments, the meter values provided later may therefore indirectly indicate the amount of energy charged during the transaction, because CSMS 120 may calculate the amount of energy charged during the current transaction based on the difference between the meter value reported by charging station 110 and the initial meter value. The start transaction message may comprise a StartTransaction message of OCPP. However, similar information may be transmitted in any suitable type of control message(s). In response to receiving the start transaction message, CSMS 120 may perform prepare for energy transfer between charging station 110 and electric vehicle 112. For example, CSMS 120 may determine the target amount of energy (E_{target}) to be charged to electric vehicle 112, for example based on payment information associated with the customer charging electric vehicle 112.

At operation 602, charging station 110 may transmit a meter value, for example as, or within, a charging report associated with the current reporting interval. The meter value may indicate the amount of energy charged so far, either directly or together with the initial meter value optionally provided at operation 601. Alternatively, the meter value may indicate the amount of energy charged during the current reporting interval or a separate meter value may be provided to indicate the amount of energy charged during the current reporting interval. In general, CSMS 120 may receive a charging report comprising an indication of the amount of energy charged to electric vehicle 112.

As described above, charging station 110 may be configured to transmit charging reports at regular or dynamically adjustable reporting intervals. For example, referring back to FIG. 4, CSMS 120 may have received an indication of a first amount of energy (E₄) charged to electric vehicle 112 at the end of the previous reporting interval. CSMS 120 may further receive an indication of a second amount of energy (E₅) charged to electric vehicle 112 at the end of the current reporting interval.

At operation 603, CSMS 120 may calculate charging rate of the current reporting interval. The charging rate may comprise an average charging power of the current reporting interval. The charging rate of the current reporting interval may be determined for example based on the first amount of energy (E₄) and the second amount of energy (E₅), or by any other suitable means as described above.

At operation 604, CSMS 120 may estimate the remaining charging time. The remaining charging time may be estimated based on an amount of energy (e.g. E₅) charged until the end of the current reporting interval, the charging rate of the current reporting interval determined at operation 604, and the target amount of energy (E_{target}). CSMS 120 may for example first calculate the remaining amount of energy to be charged (E_{remaining}) and estimate the remaining charging time based on the remaining energy and the charging rate of the current reporting interval, as described above.

At operation 605, CSMS 120 may set a limit to maximum charging rate if the remaining charging time meets a condition. The maximum charging rate may be determined based on the charging rate of the current reporting interval. The maximum charging rate may be for example equal (or substantially equal) to the charging rate of the current reporting interval. Alternatively, the maximum charging rate may be set lower, for example such that the target energy is reached at the end of one of the subsequent reporting intervals when charging with the maximum charging power. The maximum charging rate may be set for one or more subsequent reporting intervals. In general, the maximum charging power may be set to any suitable value, but the remaining charging time may need to be estimated again, if the maximum charging power is different from the charging rate of the current reporting interval. Setting the maximum charging rate to the charging rate of the current reporting interval therefore reduces computational complexity.

The condition may comprise a threshold for the remaining charging time. The maximum charging rate may be therefore set in response to determining that the remaining charging time is lower, or equal to, the threshold. The threshold may be dependent on the length of the current reporting interval. For example, the threshold may be set to be an integer multiple (e.g. five times) of the length of the current reporting interval. The threshold may be therefore proportional to the length of the current reporting interval. Dependency of the threshold from the reporting interval enables to set the maximum charging rate at an appropriate time at the final phase of the charging transaction. Determination of the threshold is also computationally efficient, since the threshold may be determined by a multiplication of the length of the current reporting interval. Since transmission of the charging reports, and therefore also the accuracy of delivering the target amount of energy, are linked to the length reporting interval, it may be beneficial to set the threshold to be dependent on the length of the reporting interval. Five times the current reporting interval has been considered to provide a good solution in practice.

The threshold may be configurable, for example automatically by CSMS 120 or manually by a user. The threshold may be for example adjusted based on feedback on the accuracy of delivering the target amount of energy to electric vehicle 112 or other electric vehicles. Charging station 110 may report the total amount of charged energy to CSMS 120 after terminating the charging. CSMS 120 may receive such reports also from other charging stations. CSMS 120 may reconfigure the threshold based on the feedback from the charging station(s). For example, if the difference between the target amount of energy and the reported amount of energy is lower than (or equal to) a second threshold, CSMS 120 may decrease the threshold for the remaining charging time for subsequent charging transaction(s). This enables to increase the amount of time the electric vehicle 112 can be charged without the limitation of the maximum charging rate. If the difference between the target amount of energy and the reported amount of energy is higher than (or equal to) the second threshold, CSMS 120 may increase the threshold for the remaining charging time for subsequent charging transaction(s). If reports are received from multiple charging stations, CSMS 120 may combine the reports, for example using the average difference between the target amount and reported amount of energy. This enables the charging rate to be controlled earlier during the charging transaction, which may result in more accurate delivery of the target amount of energy. The threshold may be therefore configurable, for example based on accuracy, e.g. (average) difference between target amount and reported amount of charged energy, of one or a plurality of previous charging transactions.

At operation 606, CSMS 120 may transmit an indication of the maximum charging rate (e.g. a power limit) to charging station 110. Charging station 110 may configure charging of electric vehicle 112 accordingly. Charging station 110 may for example limit the charging rate of electric vehicle 112 to the indicated maximum charging rate. CSMS 120 may send the indication of the maximum charging rate to cause the charging rate of electric vehicle 112 to be limited to the maximum charging rate.

At operation 607, CSMS 120 may set a charge stop time. The charge stop time may comprise an estimate of the time at which charging station 110 should stop charging electric vehicle 112 to reach the target amount of energy. CSMS 120 may determined the charge stop time based on the remaining charging time estimated at operation 605. The charge stop time may be determined by adding the remaining charging time to the current time, the time stamp of the charging report associated with the current reporting interval, or the reception time of the charging report. Determining the charge stop time may comprise initiating a timer, for example with the value of the remaining charging time. If a charge stop time was previously set, CSMS 120 may replace the previous charge stop time with the new charge stop time. For example, value of the timer may be updated accordingly.

At operation 608, CSMS 120 may receive a new meter value. The new meter value may be received in a charging report associated with the subsequent reporting interval. It is however possible that the charge stop time is reached before receiving the new meter value, as will be further described with reference to operation 609. Operation 608 is therefore optional.

At operation 609, CSMS 120 may determine whether the charge stop time has been reached before receiving a new meter value. CSMS 120 may for example monitor the timer and determine the charge stop time to have been reached, in response to detecting expiry of the timer. Alternatively, the charge stop time may comprise an absolute time (e.g. 09:46:02) and the CSMS 120 may determine the charge stop time to have been reached, in response to detecting its internal clock to have reached this absolute time. If a new meter value is received (operation 608) before reaching the charge stop time, CSMS 120 may move back to operation 603 to calculate the charging rate for the subsequent reporting interval, which may be then considered as the current reporting interval. If the charge stop time has been reached before receiving a new meter value, CSMS 120 may move to operation 610.

At operation 610, CSMS 120 may transmit a stop charging command to charging station 110, in response to reaching the charge stop time at operation 609. The stop charging command may comprise RemoteStopTransaction command of OCPP. However, any suitable control message may be used instead. In response to receiving the stop charging command, charging station 110 may stop charging electric vehicle 112. Since the charge stop time was set based on the maximum charging rate, the target amount of energy will not be exceeded. CSMS 120 may therefore transmit the stop charging command to cause termination of charging electric vehicle 112.

Optionally, at operation 607 CSMS 120 may transmit an indication of the determined charge stop time to charging station 110. This may be done to cause the charging station 110 to autonomously terminate the charging at the determined charging time. Therefore, in some example embodiments CSMS 120 may not need to keep monitoring for the charge stop time. Operation 609 may be therefore optional and CSMS 120 may iterate operations 603 to 607 whenever new meter values are received, until the charging is terminated. CSMS 120 may therefore cause termination of the charging (substantially) at the charge stop time, for example by transmitting an indication of the charge stop time to charging station 110 or by transmitting a stop charging command to charging station 110, in response to reaching the charge stop time.

FIG. 7 illustrates an example of a message sequence and operations for determining a maximum charging rate, adjusting a reporting interval, and determining a charging stop time. The procedure of FIG. 7 may comprise operations 601 to 607, as described above. In this example, determining the charge stop time based on the determined maximum charging rate, as described with reference to FIG. 4 and/or FIG. 6, is combined with the dynamic adjustment of the reporting interval (cf. FIG. 5). It is however possible that operations 605 and 606 are omitted. Hence, dynamic adjustment of reporting interval may be applied with or without setting the maximum charging rate.

At operation 708, CSMS 120 may determine whether charging station 110 supports dynamic adjustment of reporting interval. Charging station 110 may transmit an indication (e.g. a binary flag) of whether it supports dynamic adjustment of reporting interval. This may be done for example at the beginning of the charging transaction. The start transaction message of operation 601 may for example include an indication that charging station 110 supports (or does not support) dynamic adjustment of reporting interval. If charging station 110 does not support dynamic adjustment of reporting interval, CSMS 120 may move to operation 712 to determine whether the charge stop time has been reached before receiving a new meter value, similar to operation 609. If charging station 110 supports dynamic adjustment of reporting interval, CSMS 120 may move to operation 709.

Operation 708 may be optional. For example, if all charging stations are mandated or otherwise known to be configured to support dynamic adjustment of reporting interval, CSMS 120 does not need to perform this determination. However, operation 708 enables to optimise the charging procedure in case all charging stations do not support or are not known to support this feature.

At operation 709, CSMS 120 may determine whether the remaining charging time meets a condition, for example as described with reference to operation 605. The condition for moving to operation 710 for adjusting the reporting interval may be the same condition that was applied operation 605. If the condition is met, for example the remaining charging time is below, or equal to, the threshold, CSMS 120 may move to operation 710. If the condition is not met, CSMS 120 may move to operation 712.

At operation 710, CSMS 120 may adjust the reporting interval. CSMS 120 may determine an adjusted length for one or more subsequent reporting interval(s). The adjusted length of the subsequent reporting interval may be shorter than the length of the current reporting interval. CSMS 120 may adjust the length of the subsequent interval in the sense that the adjusted length is different from the length of the current reporting interval. Shortening the length of the reporting interval increases granularity of the reported meter values and thereby enables the charge stop time to be set more accurately. The adjusted length of the subsequent reporting interval may be dependent on, for example proportional to, the remaining charging time. The adjusted length of the subsequent reporting interval may be for example substantially half of the current reporting interval. The adjusted length may be rounded to the closest value that can be signalled to charging station 110.

At operation 711, CSMS 120 may transmit an indication of the adjusted length of the subsequent reporting interval to charging station 110. Charging station 110 may then configure transmission of the charging reports according to the adjusted reporting interval. From operation 711 CSMS 120 may move to operation 712.

At operation 712, CSMS 120 may determine whether the charge stop time has been reached before receiving a new meter value, similar to operation 609. If the charge stop time has been reached, CSMS 120 may move to operation 603 to calculate the charging rate for the subsequent reporting interval. If the charge stop time has been reached, CSMS 120 may move to operation 713. It is noted that any time at or between operations 708 to 711, CSMS 120 may receive a new meter value, similar to operation 608. The possible transmission of the new meter value is however not depicted in FIG. 7 for simplicity.

At operation 713, CSMS 120 may transmit a stop charging command to charging station 110, similar to operation 610.

The procedure of FIG. 7 enables to combine limiting the charging rate of electric vehicle 112 and shortening the length of the reporting interval towards the end of charging. This combination further improves the accuracy of delivering the target amount of energy to electric vehicle 112.

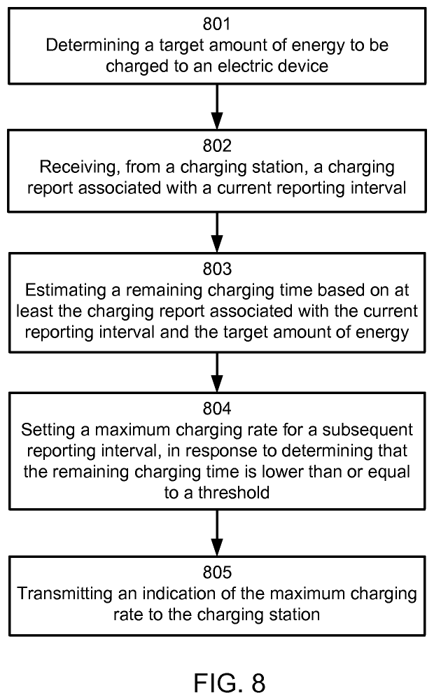

FIG. 8 illustrates an example of a method for controlling charging of an electric device.

At 801, the method may comprise determining a target amount of energy to be charged to an electric device.

At 802, the method may comprise receiving, from a charging station, a charging report associated with a current reporting interval.

At 803, the method may comprise estimating a remaining charging time based on at least the charging report associated with the current reporting interval and the target amount of energy.

At 804, the method may comprise setting a maximum charging rate for a subsequent reporting interval, in response to determining that the remaining charging time is lower than or equal to a threshold.

At 805, the method may comprise transmitting an indication of the maximum charging rate to the charging station.

Further features of the method(s) directly result for example from example embodiments of the CSMS 120 and/or other devices, as described throughout the specification and in the appended claims. Different variations of the method(s) may be also applied, as described in connection with the various example embodiments.

An apparatus, may be configured to perform or cause performance of any aspect of the method(s) described herein. A computer program or a computer program product may comprise instructions for causing, when executed, an apparatus to perform any aspect of the method(s) described herein. A non-transitory computer readable medium may comprise program instructions for causing an apparatus to perform any aspect of the method(s) described herein. An apparatus may comprise means for performing any aspect of the method(s) described herein. According to an example embodiment, the means comprises at least one processor, and memory including program code, the at least one processor, and program code configured to, when executed by the at least one processor, cause the apparatus to perform any aspect of the method(s) described herein.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item, ‘at least one’ item, and ‘one or more’ items may refer to one or more of those items or a plurality of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and at least one memory including computer program code; the at least one memory and the computer program code configured to, with the at least one processor, cause the apparatus at least to:
determine a target amount of energy to be charged to an electric device;
receive, from a charging station, a charging report associated with a current reporting interval;
estimate a remaining charging time based on at least the charging report associated with the current reporting interval and the target amount of energy;
set a maximum charging rate for a subsequent reporting interval, in response to determining that the remaining charging time is lower than or equal to a threshold; and
transmit an indication of the maximum charging rate to the charging station.

2. The apparatus according to claim 1, wherein the at least one memory and the computer program code are further configured to, with the at least one processor, cause the apparatus to:
determine a charge stop time based on the remaining charging time; and
transmit a stop charging command to the charging station, in response to reaching the charge stop time, or
transmit an indication of the charge stop time to the charging station.

3. The apparatus according to claim 1, wherein the at least one memory and the computer program code are further configured to, with the at least one processor, cause the apparatus to:
receive a charging report associated with a previous reporting interval comprising an indication of a first amount of energy charged to the electric device at an end of the previous reporting interval, wherein the charging report associated with the current reporting interval comprises an indication of a second amount of energy charged to the electric device at an end of the current reporting interval;
determine a charging rate of the current reporting interval based on the first amount of energy, the second amount of energy, and a length of the current reporting interval;
estimate the remaining charging time based on the second amount of energy, the charging rate of the current reporting interval, and the target amount of energy.

4. The apparatus according to claim 1, wherein the charging report comprises an indication of an amount of energy charged to the electric device during the current reporting interval, and wherein the at least one memory and the computer program code are further configured to, with the at least one processor, cause the apparatus to:
determine a charging rate of the current reporting interval based on the amount of energy charged during the current reporting interval and a length of the current reporting interval; and
estimate the remaining charging time based on an amount of energy charged to the electric device at an end of a previous reporting interval, the charging rate of the current reporting interval, and the target amount of energy.

5. The apparatus according to claim 3, wherein the maximum charging rate is substantially equal to the charging rate of the current reporting interval.

6. The apparatus according to claim 3, wherein the threshold is dependent on the length of the current reporting interval, wherein the threshold is proportional to the length of the current reporting interval, or wherein the threshold is configurable.

7. The apparatus according to claim 6, wherein the threshold comprises an integer multiple of the length of the current reporting interval.

8. The apparatus according to claim 7, wherein the threshold is substantially equal to five times the length of the current reporting interval.

9. The apparatus according to claim 1, wherein the at least one memory and the computer program code are further configured to, with the at least one processor, cause the apparatus to:
determine an adjusted length for the subsequent reporting interval, wherein the adjusted length of the subsequent reporting interval is shorter than a length of the current reporting interval; and
transmit an indication of the adjusted length of the subsequent reporting interval to the charging station.

10. The apparatus according to claim 9, wherein the at least one memory and the computer program code are further configured to, with the at least one processor, cause the apparatus to:
determine the adjusted length of the subsequent reporting interval, in response to determining that the remaining charging time is lower than or equal to the threshold.

11. The apparatus according to claim 9, wherein the adjusted length of the subsequent reporting interval is dependent on the remaining charging time, wherein the adjusted length of the subsequent reporting interval is proportional to the remaining charging time, or wherein the adjusted length of the subsequent reporting interval is substantially half of the current reporting interval.

12. The apparatus according to claim 9, wherein the at least one memory and the computer program code are further configured to, with the at least one processor, cause the apparatus to:
determine the adjusted length of the subsequent reporting interval, in response to determining that the charging station supports dynamic adjustment of reporting interval.

13. The apparatus according to claim 1, wherein the electric device comprises an electric vehicle.

14. A method comprising:
determining a target amount of energy to be charged to an electric device;
receiving, from a charging station, a charging report associated with a current reporting interval;
estimating a remaining charging time based on at least the charging report associated with the current reporting interval and the target amount of energy;
setting a maximum charging rate for a subsequent reporting interval, in response to determining that the remaining charging time is lower than or equal to a threshold; and
transmitting an indication of the maximum charging rate to the charging station.

15. A computer program comprising program code configured to cause an apparatus at least to:
determine a target amount of energy to be charged to an electric device;
receive, from a charging station, a charging report associated with a current reporting interval;
estimate a remaining charging time based on at least the charging report associated with the current reporting interval and the target amount of energy;
set a maximum charging rate for a subsequent reporting interval, in response to determining that the remaining charging time is lower than or equal to a threshold; and
transmit an indication of the maximum charging rate to the charging station.
